(19) United States
(12) Patent Application Publication
(10) Pub. No.: US 2019/0292466 A1
(43) Pub. Date: Sep. 26, 2019

(54) CONTROL, METHOD FOR PYROLYSIS PROCESS OF LOW-RANK-COAL

(71) Applicants: Dennis Carl England, Cote de Caza, CA (US); William A. Farone, Irvine, CA (US)

(72) Inventors: Dennis Carl England, Cote de Caza, CA (US); William A. Farone, Irvine, CA (US)

(21) Appl. No.: 15/936,216

(22) Filed: Mar. 26, 2018

(51) Int. Cl. C10B 53/06; C10B 41/00; G06F 17/15; G06F 17/18

(52) U.S. Cl. CPC C10B 53/06; G06F 17/18; G06F 17/156; C10B 41/005

(57) ABSTRACT

A process control method for the on-line operation in real time of a low-rank-coal pyrolysis process producing a coal-char product, a pyrolysis gas, and a complex multi-component coal-tar-oil. The control method is based on measuring the concentration of selected compounds in the three products, a solid phase, a gas phase and a liquid phase condensed from the gas-phase, using a combination of spectrometric technology including scanning in the infrared, visible, ultraviolet and microwave spectral regions, and analyzing the data based on application of a modified Chi-Square data manipulation fitting technique developed for the specific products and process. This process control method provides a basis for accurate on-line control of the process operating parameters and allows optimization of the coal-char quality as well as the quality and yield of the extracted coal-tar-oil with unique chemical composition derived from low-rank coal in a pyrolysis process. The subject invention is based on the selection of 2-6 key compounds contained in each product to be measured and used as control point, calibration of the process operating conditions to the key compound composition and monitoring the changes in concentration on-line in real time.

### CROSS-REFERENCE TO RELATED APPLICATION

This application claims the benefit of priority to U.S. Provisional Patent Application No. 62/601,521, filed Mar. 27, 2017, entitled “Control Method for Pyrolysis Process for Low-Rank Coal”, the content of which is hereby incorporated by reference in their entireties.

### FIELD OF THE INVENTION

The present invention relates to a system and a method for monitoring and controlling the process and intermediate products in transition during drying, dry distillation, pyrolysis and extraction of coal-tar oil and pyrolysis gas from low-rank coal. More specifically, the invention pertains to a control system that has the capability to perform on-line analysis of the composition of the intermediate transition products directly, on-line preparation of the hot pyrolysis gas and oil vapor samples for analysis, development of correlation factors between product quality and essential key components in the pyrolysis gas effluent, and on-line closed loop control in real-time of operating variables.

### BACKGROUND

Low rank coals (LRC) are the less transformed younger coals that include lignite, brown-coal, sub-bituminous and some bituminous coals. Together these coals comprise two-thirds or more of the coal resources in the world and three-quarters of the current U.S. coal supply.

The low rank coal generally has a relatively high content of “volatile matter” (VM) ranging from 25-45-wt % or 30-55 wt % on moisture-ash-free (MAF) basis. A significant amount of coal-tar-oil therefore can be recovered from these coals. For example, a typical sub-bituminous coal from the Powder River Basin, Wyoming containing 30-wt % moisture, 5-wt % ash and 33-wt % VM “as mined”, will yield approximately 11.5-wt % coal-tar-oil and 50-wt % clean-coal fuel.

LRC processing with mild-temperature pyrolysis was developed and commercialized in several plants in the 1920s, notably in Britain, Germany and Belgium for the purpose of producing coal chemicals. The viability was based on having access to special feed-coals of limited availability and a market for chemical intermediate products that could support the relatively high processing cost. Competition from petroleum based petrochemicals eventually led to termination of these specialized commercial LRC pyrolysis operations.

With the increasing cost trend of petroleum based products, the potential economic result from recovery of coal-tar-oil and conversion to synthetic crude oil is attractive at half of current crude oil price and becomes compelling as crude oil cost increases. During the past decade, the supply of LRC for power generation has grown to approximately 750-million ton per year, corresponding to 70% of the domestic coal supply. Specifically, low rank coal is desirable for power production mainly due to low sulfur content, high volatility and relatively low cost of mining.

During the past 30 years, a considerable amount of process development work has been done to improve the LRC pyrolysis process, and notable examples of new processes and demonstration projects include Allis Chalmers, ERC-AMAX, FMC-COED, Occidental Flash Pyrolysis, TOSCO-Coal, Western SynCoal, and Encoal SGI-SMC. However, none of these processes arrived at commercial viability, in part due to operability issues, limited yield of the recovered oil, and cost of operation.

Until recently, however, the economics of LRC processing has not been able to support commercial conversion of LRC to oil and coal-char for clean-coal-fuel use in power generation plants. Firstly, the coal tar oil quality was incompatible with petroleum refining operations; secondly, the available coal conversion process technologies were deficient with regard to energy use and CTO yield; and thirdly, the conversion cost using existing conversion processes was too high to be economically viable.

Major process technology hurdles that have been recognized as serious impediments to successful processing of LRC include the following: (1) pronounced friability of LRC leading to the formation of coal-fines that can impede oil recovery and good control of mass flow and time-at-temperature; however, non-friable softening higher-rank coals tend to disable the process equipment and are not suitable for mild-temperature pyrolysis, (2) High demand for heat transfer during the conversion process and limitations to the maximum allowable operating temperatures imposed on both direct contact heating and indirect heating, (3) When direct-contact heating-gas is used for the pyrolysis an excessively large volume is required resulting in large dilution of the pyrolysis gas and oils, in turn leading to costly and inadequate oil recovery, (4) Equipment related limitations of indirect heating heat transfer, (5) Oil recovery process is difficult due to phase separations, the wide range of viscosity, boiling points and individual polar and non-polar compounds found in the LRC coal-tar-oil and (6) the quality of the recovered pyrolysis coal-tar-oil must be improved to meet oil refining operability specifications.

In order to overcome these hurdles, process control systems were designed that monitor the final products quality by taking discrete samples every hour, analyzing in the laboratory and providing the results back to the process operator several hours later. The operator then controls the operating parameters to get the final product with desired quality. Such control schemes cannot provide minute to minute optimization of product yields and quality. It is important to understand that there is a considerable time lag of 15-45 minutes between the composition change of the intermediate transition products (partly transformed coal-char and coal-tar-oil) and the final products, and additional time lag in obtaining the lab results (30-60 minutes depending on the lab facilities), plus the factor that lab samples conventionally are acquired with a frequency of only once every 1-2 hours. Therefore, because the operator must operate in a mode that is always “conservatively safe” with regard to product specifications and operating variables, given the considerable time lag between obtaining actual product composition data and making process control adjustments, the actual processing operation will be conducted at some distance from the product quality specifications and the process economic optimum. This becomes problematic when we consider the variability of composition of feed-coal, coal diminution during processing, changes in oil diffusion as it relates to coal particle size and temperature, pyrolysis process residence time, and the interaction between oil yield, indirect heating of the pyrolyzer vessels and direct heating-gas temperature and velocity.

The desirability of extracting volatile coal-tar oil present in Low Rank Coal while upgrading the coal to clean burning and more efficient power-plant fuel [CCF] has been understood many years. The absence of on-site real-time process control systems for products and process control were a contributing cause of the lack of success of many other coal pyrolysis processes tested during the past thirty years.

Therefore, a novel process control system and design for mild-temperature pyrolysis of LRC is required. The process control system should be based on monitoring directly the intermediate solid phase, liquid phase and gas phase products as they change composition during processing. On-line process control adjustments of the key operating variables in real-time would be based on monitoring product composition along the path of pyrolysis processing, including the control of operating temperatures, residence time, and heating-gas flow.

### SUMMARY OF THE INVENTION

In a first aspect of the invention, a method for real-time monitoring and on-line control of a low-rank-coal pyrolysis process is provided. The method comprising: monitoring and measuring by a plurality of measuring instruments, the composition of an solid phase, a gas phase and a liquid phase in an intermediate stage of pyrolysis process, and determining the concentration of a plurality of compounds in each phase; analyzing data on the measured concentration of the plurality of compounds, utilizing a modified chi-square data manipulation fitting technique to determine a correlation factor between an end-product composition quality and the concentrations of the plurality of compounds in the intermediate solid phase, the gas phase and the liquid phase; providing an online closed loop control of one or more operating variables in real time, wherein on determining deviation in one of the plurality of compound, a feedback is given to a control system to control one or more operating variables.

The low-rank coal comprises lignite or sub-bituminous (A, B and C) coals, or bituminous C coals and blends of lignite, sub-bituminous and bituminous coals that together have processing characteristics similar to sub-bituminous coal with respect to non-agglomeration and softening point range. The low-rank-coal pyrolysis is a mild-temperature pyrolysis process, where the feed coal is heated within a range of 450° C. to 700° C. The pyrolysis process is a multi-step coal conversion process that includes the feed-coal preparation, drying, distillation and pyrolysis of low-rank coal.

The plurality of measuring system and the control system are positioned at several locations along the path of mass flow during feed-coal preparation, drying, distillation and pyrolysis process. The plurality of measuring instruments may comprise a combination of spectrometric technology including scanning in the infrared, visible, ultra-violet and microwave spectral regions.

The process is conducted by means of and in a manner that the operating control variables permit optimization of the processing conditions of temperature, gas flow and pressure so as to allow optimization of the quality and material balance between the solid, liquid and gas phase products. The plurality of measuring instruments provide near-instant feedback to the control system including controls for temperature, pressure, flow of gases, liquids and solids, product quality and throughput, so that the operating variables can be adjusted within minutes or fractions thereof to allow more accurate control and maintain narrow control-error limits around the designated set-point values. Controlling the one or more operating variable compensates for coal friability, reduction of particle size and changes in coal quality and composition in real-time. The one or more operating variables comprise pressure, gas flow rate, temperature, residence time, heating gas composition and gas velocity.

The plurality of compounds in the solid phase, gas phase and liquid phase that are used for identifying relation between their composition and the end-product quality are 3 to 12 control compounds selected from the group of 1200 key constituents present in the intermediate stages of pyrolysis process. These 1200 chemical compounds present in the coal tar oil produced during the pyrolysis process include hydrocarbons and compounds containing several oxygen, sulphur and nitrogen atoms. The coal-tar-oil characterization and composition are provided in several papers presented by Ebbe R. Skov at the AIChE National Conference, Houston, Tex., April 2007, and CTL conference, Freiberg, Germany, May 2007.

The end-products of the pyrolysis process are a coal-char product, a pyrolysis gas, and a complex multi-component coal-tar-oil. The desired coal-char product composition quality include maximum allowable residual amounts of mercury, sulfur, nitrogen, water, volatile compounds and ash, and minimum allowable amounts of water, pyrolysis oil compounds, and volatile compounds, wherein: the maximum weight percent (wt %) residual amount of mercury is below 250-parts-per-billion (ppb) or 150 ppb or 100 ppb or 50 ppb or 10 ppb or 1 ppb; the maximum wt % residual amount of sulfur is below 1.5 or 1 or 0.9 or 0.5 or 0.2; the maximum wt % residual amount of nitrogen is below 1.5 or 1 or 0.9 or 0.5 or 0.2; the water maximum (defined as humidity) wt % residual amount is below 8 or 6 or 1.5 or 0.5 or 0.2; the water (defined as pyrolysis removable) maximum wt % residual amount is less than 4 or 3 or 2 or 0.5; the maximum wt-% of ash is a factor of N times the amount in the feed-coal, where N can be 2.5 or 2.2 or 2.0 or 1.8 or 1.6 or 1.4 or 1.2; the minimum wt % of volatile compounds as defined by the relevant ASTM method is 5 or 8 or 10 or 12 or 15.

The desired processed coal-tar-oil composition quality include maximum allowable amounts of compounds with molecular weight above 350 Dalton and atmospheric equivalent boiling point (AEBP) range above 900° C. and minimum allowable amount of pyrolysis oil compounds including phenols, cresols, aliphatic hydrocarbons, olefins, aromatic compounds, polynuclear aromatic compounds, sulfur compounds, nitrogen compounds, and oxygen compounds, wherein: the maximum wt % amount of 350+ Dalton material is less than 15 or 10 or 5 or 1; the maximum wt % with AEBP above 900° C. is less than 25 or 20 or 15 or 10 or 5 or 2.

The end-product coal-tar-oil is further hydrotreated using means of catalytic processing for converting it to a “synthetic crude oil” and the on-line control method is applied to the hydrotreating process to determine the concentration of a plurality of compounds in the intermediate stages and controlling one or more variables based on the concentration of the plurality of compounds. The hydrotreating process is continuous, and the feedstock to the hydrotreating process is either the total coal-tar oil recovered from the pyrolysis process or a fraction of the coal-tar oil recovered from the pyrolysis process or a fraction of the coal-tar oil recovered from the pyrolysis containing most of the olefinic compounds or a fraction of the coal-tar oil recovered from the pyrolysis containing most of the sulfur and/or nitrogen compounds or a fraction of the coal-tar oil recovered from the pyrolysis containing most of the high-molecular and high boiling range compounds or a mixture of various fractions of the coal-tar oil recovered from the pyrolysis containing various proportions of the recovered compounds. Different feedstock, require separate catalyst and operating conditions and therefore, the processing conditions and catalyst can be selected and optimized for each feedstock.

### BRIEF DESCRIPTION OF DRAWINGS

The preferred embodiment of the invention will hereinafter be described in conjunction with the appended drawings provided to illustrate and not to limit the scope of the invention, wherein like designation denotes like element and in which:

FIG. 1 illustrates a schematic process block diagram of a mild-temperature pyrolysis process of a low rank coal, in accordance with an embodiment of the present invention.

FIG. 2 illustrates a pyrolysis section where feedstock is converted into coal-char product and pyrolysis gas and oil vapor, in accordance with an embodiment of the present invention.

FIG. 3 illustrates an oil recovery and separation process sections, in accordance with an embodiment of the present invention.

### DETAILED DESCRIPTION OF THE INVENTION

In the following detailed description of embodiments of the invention, numerous specific details are set forth in order to provide a thorough understanding of the embodiments of the invention. However, it will be obvious to a person skilled in art that the embodiments of the invention may be practiced with or without these specific details. In other instances, well known methods, procedures and components have not been described in detail, so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

The present invention provides a system and a method for controlling the quality of end-product in a low rank coal pyrolysis process by monitoring the concentrations of selected compounds present in the intermediate stages of pyrolysis process. The solid phase, liquid phase and the gas phase at intermediate stages are monitored to determine the concentration of different compounds present. The process monitors the intermediate products in transition during drying, dry distillation, pyrolysis and extraction of coal tar oil and pyrolysis gas from low rank coal that include lignite, brown coal, sub-bituminous and some bituminous coal. The method and the system has the capability to perform on-line analysis of the composition of the intermediate products directly or through on-line preparation of hot pyrolysis gas and oil vapor samples for analysis, development of correlation factors between the end-product quality and 3-12 key components in the pyrolysis gas effluent and on-line closed loop control in real-time of operating variables. The operating variable includes but is not limited to coal residence time and operating temperature, heating gas composition, gas flow and temperature.

In a mild-temperature pyrolysis of low rank coal operating up to 600° C. [1112° F.], the process control system based on monitoring directly the intermediate solid phase and gas phase products as they change composition during processing, is important for on-line process control and product quality optimization. The composition of the intermediate products changes in accordance with the processing temperature, heating gas flow, coal particle size and residence time. On-line process control adjustments of the key operating variables in real-time would be based on monitoring product compositions along the path of pyrolysis processing, including the control of operating temperatures, residence time, and heating-gas flow. One of the unexpected benefits of this novel control scheme is the capability to make process control adjustments that can compensate for coal friability, reduction of particle size, and changes in coal quality and composition in real-time.

The process control system of the present invention is a functional, reliable analytical component of an on-line control system for mild-temperature pyrolysis coal-tar-oil derived from LRC, which contain more than 1200 identified different chemical compounds. The system utilizes a sub-set of these compounds (control compounds) and monitors the concentration of these “control compounds”. The concentration of these control compounds are correlated with the yield and composition of the final product across the spectrum of the principal operating control variables, temperature, residence time, heating-gas composition and velocity.

The end products of the mild-temperature pyrolysis of low rank coal generates end products in the form of coal-tar-oil, coal char fuel and pyrolysis gas. The compositions of the produced oils, gases and coal-char products are unique as a result of the combination of feed-coal quality and pyrolysis processing conditions. Product quality and yield optimization requires special means of analytical monitoring of the product compositions. The system and method of the present invention provides optimization of the coal-char oil and coal tar oil product qualities and yields by providing real time analytical monitoring of product composition. The system and method for process control provides analytical on-line sample preparation of pyrolysis gas containing coal fines and condensable coal-tar-oils with a boiling range of 250° F.-1400° F. [equivalent atmospheric boiling point]. The invention includes resolving the sample preparation, combination of FT-IR instrumentation and calibration of the product composition based on selection of a relatively small number of key compounds from more than 1200 volatilized gas and oil compounds, and application to LRC and mild-temperature pyrolysis. The novel control system allows for real-time process optimization with regard to minimizing process variations as well as on-line optimization of the process operating variables.

The present invention consists of a combination of a set of process control systems in the application to the mild-temperature pyrolysis process where the feed coal is sub-bituminous coal, lignite or some bituminous coals with non-caking characteristics—together known as low-rank coals, and where the process and products are monitored in real-time and providing on-line process control through adjusting the operating conditions continually using direct reading of numerous data points taken along the progression of the process. The products from pyrolysis processing of coal are influenced by the variation in coal composition (even along the coal seam on the same mine site), coal particle size variations (relating to oil and gas diffusion), actual process temperature profile (relating to the competition between volatilization and thermal cracking). Product quality always must meet minimum requirements, and as a result product yield and plant productivity are adversely affected by these variations. With lack of having an on-line and real-time process control, a relatively small margin allowance in operating capacity or product yield can have large economic consequences when processing of large quantities of coal, e.g. 10,000-ton/day.

### Control System Description

The control system comprises a plurality of monitoring sensors, control system, control elements, analyzing instruments located at different positions in a coal processing system. There are different stages through which the mass flows during pyrolysis process, and control elements are positioned at different locations in different stages.

The control system essentially comprises a plurality of monitoring and analyzing instruments located at different stages. These instruments monitor the concentration of control compounds in solid phase, liquid phase and gas phase present in intermediate stages of the process. One type of control system that can be used to determine the concentration of control compounds in solid phase is Fourier Transform-Infrared (FT-IR) control system. The control system measures the concentration of reactants by using electromagnetic absorption technology. Each chemical compound absorbs or reflects light, which can then be used to determine the presence of compound and its concentration. Conventional Fourier Transform-IR scans the wide range of absorption spectra in a very short time. Apart from IR, the system can be adapted to scan other electromagnetic spectrums, such as UV, microwaves and visible light. The collected spectral data is analyzed by a modified chi-square technique using a general purpose computer and FT-IR instrumentation. The advantage of FT-IR (Fourier transform-Infrared) or other spectroscopic technique is that the readings can be taken every few seconds. On the other hand we are dealing with an intermediate product that contains char (a solid), coal-tar-oil (a liquid) and a gas. At different temperatures of sampling or analysis the ratio between the solid, the liquid and the gas will change. Spectroscopic techniques usually use a cell that is placed in contact with the material being analyzed or in the case of gases a cell through which the gas flows. If the solid or liquid enters a gas cell it will foul the windows and thus readings would soon become inaccurate.

In another embodiment of the present invention, the control system uses a computer controlled gas chromatograph outfitted with a continuous sampling and run system. In a gas chromatographic system, it is possible to collect samples in a chamber which is then subsequently cooled and the sample can be volatilized again into the process. Thus, char can be removed and by regulating the temperature of the chamber and the ratio of gas to liquid can be made to comply with the pyrolysis reaction system. This chamber can be programmed to admit the gas phase to the FT-IR by bypassing the chromatograph while gas and subsequently formed liquid from higher temperature pyrolysis can be analyzed on the gas chromatograph. The char particulates entrained in the gas-phase can be measured as the amount of solids collected over time based on the carbon residual formed in the chamber that can be measured periodically.

This novel procedure gives a relatively instantaneous measure of the gas phase at reactor temperature followed by periodic (e.g. 10-30 minutes later) snapshots of the liquid and non-carbon char species in the tar and char. Since the temperature in the gas chromatograph is different for each compound measured, one can determine whether it was associated with the tar-oil or the char (e.g. coal tar waxes).

The pyrolysis reaction is actually controlled from the relatively quick gas phase measurements of compositions but such controls are modified by subsequent adjustments based on indications for cases where the gas and liquid and solid do not correlate. The entire control species profile is calibrated and tested against both thermodynamic data and previous runs for coal of similar composition. During an actual lengthy operating run with coal of relatively uniform composition the control algorithm also contains the information on the previous history of composition and species ratios at the same operating temperature and pressure.

In additional embodiments, intermediate solid phase, liquid phase and the gas phase can also be monitored using additional probes to measure temperature, pressure, flow, pH, dissolved oxygen, humidity, density, weight etc.

The control system also comprises analyzing instrumentation that correlate the concentration of “control compounds” with the yield and composition of the final product across the spectrum of the principal operating control variables, temperature, residence time, heating-gas composition and velocity.

Based on the concentration of control compounds in the intermediate states, the operating variables can be controlled either manually by operator or automatically using a computing device that control switches and valves connected to the pyrolysis system at different locations.

### Process Description

The specific process application of the control system is to a mild-temperature pyrolysis process operating at up to 1200° F. [650° C.] temperature and using low-rank coals as feedstock. In principle, the subject invention combines the control method with the specific application to mild-temperature [below 1200° F., 650° C.] pyrolysis of low-rank coals [lignite, brown-coal, sub-bituminous coal and some bituminous-B and -C coals].

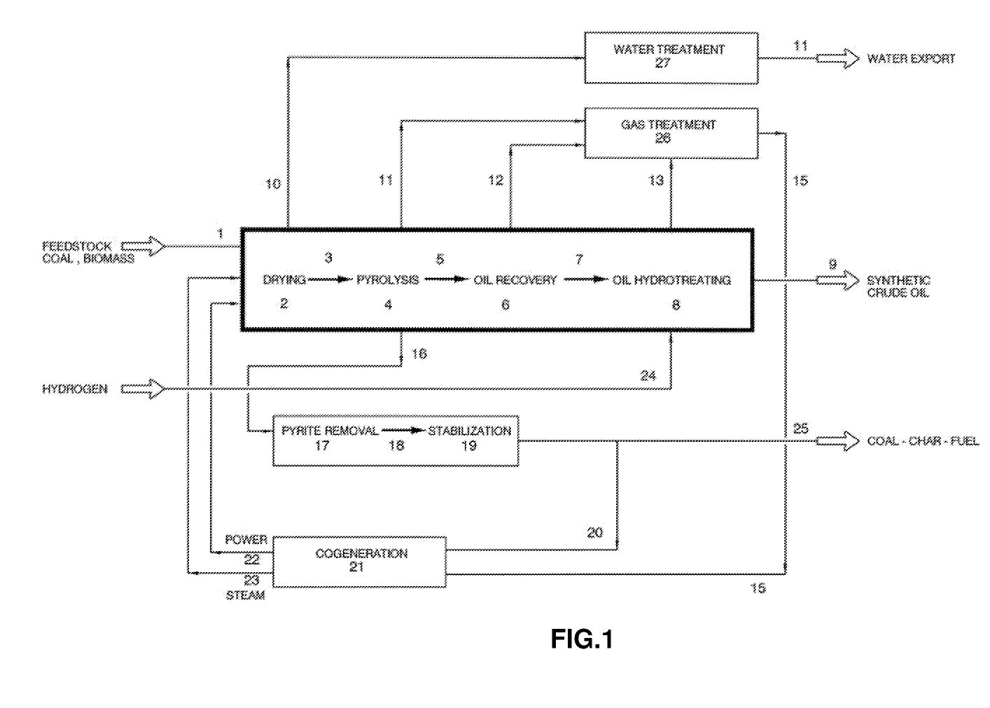

FIG. 1 illustrates a schematic process block diagram of a mild-temperature pyrolysis process of a low rank coal, in accordance with an embodiment of the present invention. The coal and/or biomass feedstock stream [1] is conveyed to drying [2] vaporizing water [10] that goes to water treatment [27]. The dried feedstock [3] feeds into the pyrolysis unit [4] where an intermediate temperature gas stream [11] is separated for mercury removal and gas treatment [26] followed by removal of the pyrolysis gas and oil [5]. The coal-char [16] feeds from pyrolysis [4] into the pyrite removal unit [17] and stabilization unit [19] for processing into coal-char-fuel product [25] before being conveyed to storage and/or captive use for co-generation [21] of power [22] and steam [23] for drying [2] and pyrolysis [4]. The pyrolysis gas and oil vapor stream [5] flows to oil recovery [6] for separation of oil [7] from pyrolysis gas [12] that flows to gas treatment [26] for clean-up of the fuel-gas [15] used for steam co-generation [21]. The condensed oil [7] flows to hydrotreating chamber [8] where it is reacted with hydrogen [24] to produce synthetic crude oil product [9] and a byproduct fuel gas stream [13] that flows to gas treatment [26].

The end-products of the pyrolysis process are a coal-char product, a pyrolysis gas, and a complex multi-component coal-tar-oil. The desired coal-char product composition quality include maximum allowable residual amounts of mercury, sulfur, nitrogen, water, volatile compounds and ash, and minimum allowable amounts of water, pyrolysis oil compounds, and volatile compounds, wherein: the maximum weight percent (wt %) residual amount of mercury is below 250-parts-per-billion (ppb) or 150 ppb or 100 ppb or 50 ppb or 10 ppb or 1 ppb; the maximum wt % residual amount of sulfur is below 1.5 or 1 or 0.9 or 0.5 or 0.2; the maximum wt % residual amount of nitrogen is below 1.5 or 1 or 0.9 or 0.5 or 0.2; the water maximum (defined as humidity) wt % residual amount is below 8 or 6 or 1.5 or 0.5 or 0.2; the water (defined as pyrolysis removable) maximum wt % residual amount is less than 4 or 3 or 2 or 0.5; the maximum wt-% of ash is a factor of N times the amount in the feed-coal, where N can be 2.5 or 2.2 or 2.0 or 1.8 or 1.6 or 1.4 or 1.2; the minimum wt % of volatile compounds as defined by the relevant ASTM method is 5 or 8 or 10 or 12 or 15.

The desired processed coal-tar-oil composition quality include maximum allowable amounts of compounds with molecular weight above 350 Dalton and atmospheric equivalent boiling point (AEBP) range above 900° C. and minimum allowable amounts designated pyrolysis oil compounds including phenols, cresols, aliphatic hydrocarbons, olefins, aromatic compounds, polynuclear aromatic compounds, sulfur compounds, nitrogen compounds, and oxygen compounds, wherein: the maximum wt-% amount of 350+ Dalton material is less than 15 or 10 or 5 or 1; the maximum wt % with AEBP above 900° C. is less than 25 or 20 or 15 or 10 or 5 or 2.

The control system effectiveness results from measuring the concentration of selected compounds present in the three pyrolysis products [solids, gas oil phase] using a combination of spectrometric technology including scanning in the infrared, visible, ultraviolet and microwave spectral regions, and analyzing the data based on application of a modified Chi-Square data manipulation fitting technique developed for the specific products and process. This process control method provides a basis for accurate on-line control of the process operating parameters and allows optimization of the coal-char quality as well as the quality and yield of the extracted coal-tar-oil with unique chemical composition derived from low-rank coal in a mild-temperature pyrolysis process as described in the following.

The following process description provides the process design basis as well as the application of the subject invention control system. The objective of the control system includes steady state operating control, operating variable adjustment for feed coal variations over time, product quality optimization for the coal-tar-oil [CTO] and coal-char fuel [CCF], reaction residence time and temperature, and recovered oil yield optimization. The subject control system allows direct monitoring of the CTO and CCF compositions and their interaction across the operating variables including variations of the operating temperature profile from inlet ambient feed to the maximum operating temperature at about 1100° F. [˜600° C.]. Those skilled in the art of coal pyrolysis will appreciate that there are categories of adjustable operating variables [temperature, pressure, flow] as well as operating variables imposed from outside that may not be adjusted as such but can be compensated for by adjusting other operating parameters.

The principal “imposed operating variables” that need to be taken into account, but are not readily adjustable as process control variables for process optimization results from the variability of the feed-coal, the selected equipment design and the process design and actual conditions of operation. These include changes of feed-coal composition over time, coal friability during processing, coal particle size distribution due to the initial milling and attrition during operation, recycle heating-gas composition and velocity as a function of the required heat content and heat transfer from gas to solid material.

The principal operating variables that are adjusted in accordance with the control system are feed rate, residence time at a given temperature, pyrolysis process temperature profile, sweeping gas volume and composition, CTO composition, and CCF composition.

There are important operating and economic benefits resulting from real-time on-line process control based on direct monitoring of the product compositions in the pyrolysis reactors at critical points along the process temperature profile. This is critical for on-line oil yield and composition optimization that directly translates to economic result of the operation.

The foregoing example of the process design is used to illustrate the combination of process and control system without thereby intending to limit the applicability of the control system and process design in any manner to the numeric values used for illustration.

The control process includes a series of processing steps that integrate unit operations and equipment into the continuous-flow design. The process design has been optimized in several important ways to improve the product yield, energy efficiency and operability while also reducing the capital cost. The three core processes sections are coal drying, pyrolysis reaction and coal-tar-oil (CTO) recovery. The supporting downstream processing sections include water and pyrolysis-gas cleanup, CTO fractionation and hydrotreating to synthetic crude oil, hydrogen production and cogeneration of steam and electricity.

To better illustrate the narrative with numeric examples, we have used an average sub-bituminous low-rank coal (LRC) from the Buckskin mine located near Gillette, Wyo. The coal contains approximately 8400-Btu/lb, 30 wt % moisture, 32 wt % volatile matter, 5 wt % ash, 3 wt % pyrolysis-water, 0.4-0.8 wt % sulfur and 180-ppb mercury.

COAL DRYING: As a first step, feed-coal is crushed and then conveyed into the coal-drying section where the moisture is reduced. Small amounts of gases volatilize with the water, including CO, CO2, NH3, CH4 and H2S. Up to 35% of the sulfur and nitrogen content in the coal also may be removed in this process step depending on the feed-coal composition, and 85-95% of the volatile mercury compounds will be removed. Several configurations of equipment in commercial use can be selected for this process step. Notable process design parameters include the amount of water removal, means of heat transfer, process gas velocity, degree of coal comminution, mercury removal and recovery, and energy optimization. The control monitoring system is applied at several locations along the path of the mass flow in the drying kiln to monitor the progression of the drying process, as well as to the gas phase leaving the drying kiln, including the kiln outlet and the gas phase after water condensation.

PYROLYSIS REACTION: After drying, the dried coal proceeds to the pyrolysis reactor where it is heated to 550° C. (1020° F.) and approximately two thirds of the “volatile material” in the feed-coal is removed as condensable coal-tar-oil and non-condensable fuel-gas. The balance is left in the residual coal-char fuel (CCF) to ensure sufficient volatility for good ignition and flame stability. The pyrolysis process removes remainder of the volatile mercury compounds from the CCF and more than half of the organic sulfur and nitrogen compounds remaining after drying.

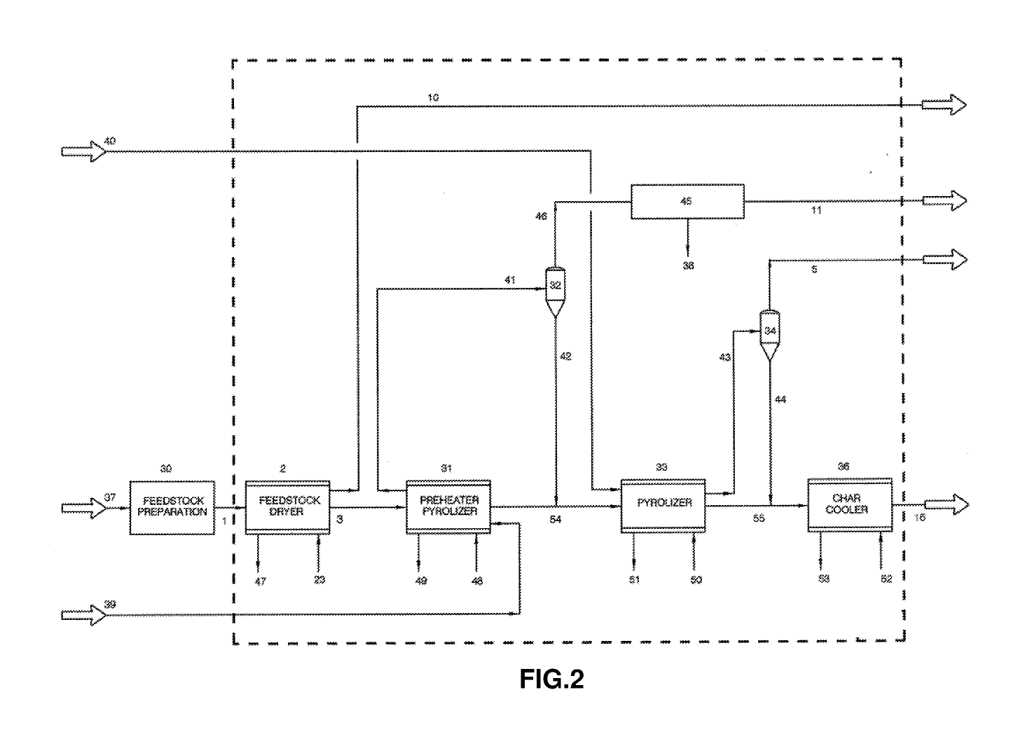

FIG. 2 illustrates a pyrolysis section where feedstock is converted into coal-char product and pyrolysis gas and oil vapor. The feedstock preparation unit [30] provides for screening, milling and weighing of feedstock [37] before it is conveyed into the drier [2] where it is heated and most of the water is vaporized [10] using steam [23] recovered from the downstream process units that exits as recycle condensate [47]. The dried feedstock [3] is fed into the preheater-pyrolysis kiln [31] which is heated in part with indirect heating medium [48, exiting 49] provided to the outside of the kiln, and in part with a direct-contact hot gas stream [39] that flows through the kiln and exits as process off-gas [41]. This process off-gas [41] contains some amount of coal-fines and most of the mercury in the coal, and it is therefore passed through a cyclone [32] for coal-fines separation and recycle [42] and an absorber [45] for recovery of mercury [38] before the off-gas [11] flows to gas treatment [26]. The preheated feedstock [54] exiting the preheater-pyrolysis kiln [31] feeds into the high temperature pyrolysis kiln [33] which is heated in part with indirect heating medium [50, exiting 51] provided to the outside shell of the kiln, and in part with a direct-contact hot gas stream [40] that flows through the kiln and exits as high-temperature pyrolysis gas [43]. The pyrolysis gas [43] is passed through a cyclone [34] for separation of recycle coal-fines [44] and pyrolysis gas [5] that flows to the oil recovery unit. The hot coal-char [55] exiting the pyrolysis kiln [33] feeds directly into the char cooler [36] that is provided with indirect cooling medium [52, exits 53] for heat recovery and cools the coal-char product [16] for pyrite removal [17] and stabilization [19] as shown on FIG. 1.

A combination of direct and indirect heating will be used in the pyrolysis unit as the coal is contacted with hot inert sweeping-gas in counter- or cross-current flow for heating and mass transfer of the volatile coal-tar-oil (CTO). The recovered oil quality and yield depend on both the feed-coal composition and pyrolysis reactor time/temperature profile, and these operating parameters predominantly determine the overall process economics. Various equipment configurations are possible for conducting the pyrolysis reaction, including horizontal travelling grates, rotating grates, or rotary kilns commonly used in minerals and petroleum-coke calcining operations. In particular, the process design takes into consideration the coal softening temperature range, temperature profile and residence time, gas phase velocity, CTO yield and gas-phase concentration, coal comminution and coal fines production, and the efficiency of heat transfer and heat recovery.

The control monitoring system is applied at several locations along the path of the mass flow in the pyrolysis reactors to monitor the progression of the pyrolysis process. The solid phase [coal, coal-char] as well as the gas phase are closely monitored including the solid and gas leaving the kiln. The samples enter the gas chromatograph chamber where they are cooled and then reheated with a known temperature profile with the gases being read by FT-IR in addition to the gas chromatograph. The molecular species that are vaporized after the operating pyrolysis temperature of the primary reactor is reached are analyzed in the gas chromatograph. Residual non-volatile carbon char is measured gravimetrically periodically. Closed loop feed-back is provided for the monitoring parameters of composition to the operating variables including the control loops for the control of temperature, pressure, mass flow, effluent gas velocity, heating-gas composition and gas composition.

COAL-CHAR COOLING AND PYRITE REMOVAL: During the pyrolysis at 550° C. (1020° F.) iron-pyrite [FeS2] will in part get converted to paramagnetic pyrrhotite [FeSx] which can then be separated. The CCF product exiting the pyrolysis reactor is cooled in a separate heat-exchange unit to 50° C. (120° F.) and further crushed and screened to minus 1-mm. It is then processed in a “magnetic material-separation” unit for removal of pyrrhotite, reducing the ash and residual sulfur content of the CCF product. The finished product is finally conveyed to an intermediate storage silo, from where it can go into the coal-char stabilization unit or directly into the adjoining PC-power plant pulverization unit. The equipment selected for this process section is found in commercial operation in various industrial applications.

The control system is applied to the pyrrhotite process in order to monitor and control the sulfur content of the CCF product. The applicable control loops include product recycle fraction, temperature control, mass flow and CCF product quality. The key measurement points are H2S along with S—H, S—C and S—S bounds in the FT-IR plus programmed Sulfur containing compounds in the gas chromatograph.

COAL-CHAR STABILIZATION: For purposes of longer time storage and transportation without using inert gas blanketing, the bone-dry CCF product will require to be “stabilized” against self-ignition in the open air, because heat generated from adsorption of atmospheric oxygen and humidity can cause spontaneous combustion. Stabilization is accomplished in a separate processing unit using carefully controlled amounts of air oxidation and humidification, adding back a total of 3-5 wt % oxygen to the CCF product. This process step has been demonstrated in several commercial capacity plants. The control system is applied to the stabilization process to monitor and control the oxygen and water uptake.

COAL-FINES HANDLING: Processing of LRC feedstock inevitably will result in comminution of some amount of the coal into coal-fines, and the amount depends on the specific coal, the equipment selection and actual processing conditions. The production of coal-fines, if not excessive, is advantageous for the adjacent PC-power plant because it unloads the coal pulverization unit. When the CCI project is located at a remote site, however, the coal-fines will need to be separated by screening and processed into briquettes using commercially available equipment. As noted, the criteria for selection of suitable feed-coal include evaluation of coal-fines production. The control system is applied to monitor the CCF product and provide feedback information with regard to coal-fines fraction and particle size distribution. Control loop feedback is provided to the upstream process sections for control of the operating variables.

PYROLYSIS OIL AND GAS RECOVERY: The recovery process for coal-tar-oil (CTO) and pyrolysis gas is presented in more detail in a separate paper, including a review of the compositions of various CTO fractions and several processing options. In summary, the volatilized coal-tar-oil (CTO) compounds are recovered from the pyrolysis reactor gas effluent by condensation. Several process configurations are feasible; however there are advantages to using a multi-stage condensing process that produces three or more distinct oil fractions, a process-water condensate, and a non-condensable fuel-gas fraction that is cleaned and used as fuel in the process. Due to the differences in composition between LRC and metallurgical coking-coals and different processing conditions (half-hour at 550° C. versus 6-hours at 1000° C.), the CTO composition from MTP is considerably different from coke-oven coal tar. For example, CTO has more low-boiling range material and less material with boiling points above 500° C. (930° F.). The recovered CTO is suitable for catalytic hydrotreating to synthetic crude oil or additional fractionation into coal tar chemical intermediate products. To be economically viable, onsite synthetic crude oil production from CTO will require a capacity in excess of 7500-barrels per day corresponding to 10,000-t/d LRC feed and matching a 500-MW PC-power generating plant.

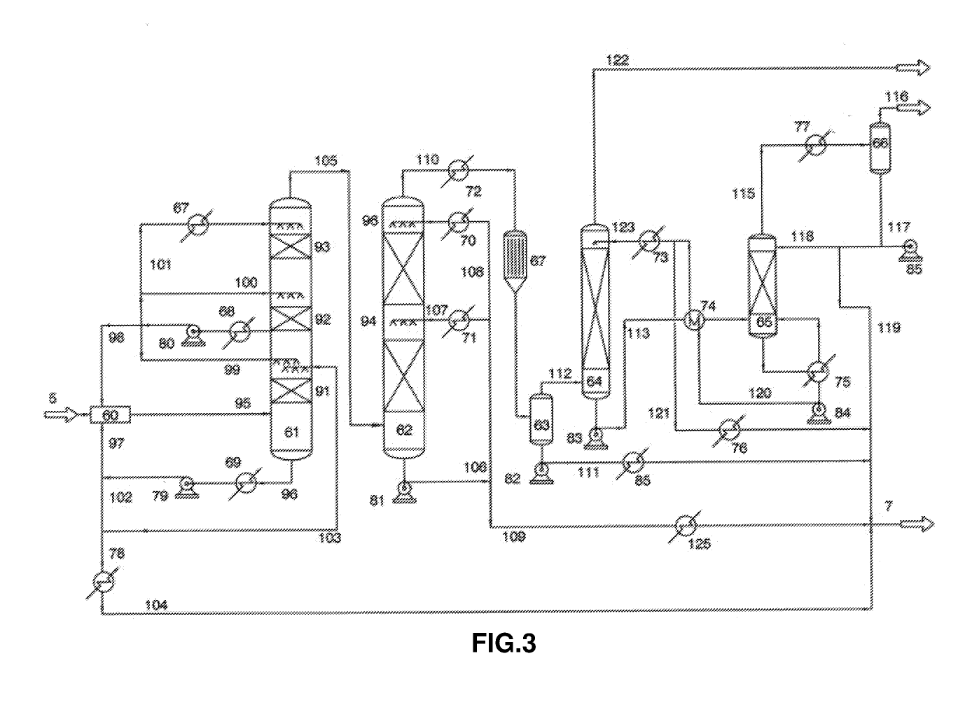

FIG. 3 illustrates an oil recovery and separation process sections in accordance with an embodiment of the present invention. The hot pyrolysis gas and oil vapor stream [5] exiting the pyrolysis unit [33] at 900-1100° F. flows into a Venturi-mixing quench device [60] and mixes with two cooled recycle oil streams [97 and 98] from the first absorber vessel [61], reducing the temperature of the gas/oil mixture [95] to below the oil cracking range as it exits the quench device and enters the absorber vessel [61]. The uncondensed gas/vapor pass upward through a quench spray-deck section [91] in contact with downwards flow of oil pumped from the vessel bottom through a pump [79] and heat exchanger cooler [69] to spray nozzles placed above the spray-deck and mixing with oil from the mid-section of the vessel flowing through a pump [80] and heat exchanger cooler [68] to spray nozzles placed above the spray-deck. Two similar absorber sections [92 and 93] are placed above the first with separate coolers [67 and 68] to control the operating temperatures as required to obtain the desired composition of the exit gas/vapor phase stream [105]. The condensed oil fraction [96] exiting at the bottom of the first absorber vessel [61] flows through a cooler [69] to a pump [79] and splits into a first recycle stream [97] going to the gas-quench mixer [60], a second recycle stream [103] going to the first spray-deck, and a third stream [104] passing through a heat exchanger cooler [78] and joining with the other oil fractions serve as an input to hydrotreating process [7]. The overhead gas phase [105] from the absorber vessel [61] flows to the second absorber vessel [62] where the oil condensation and fractionation process is repeated at lower temperatures by employing two cooled oil recycle loops [106 and 108] with a pump [81] and two heat exchanger coolers [70 and 71] to produce a second condensed oil fraction [109] that is cooled in heat exchange [125] and then joins the oil feed stream [7] serve as an input to hydrotreating process. The uncondensed gas phase [110] exiting from the top of the absorber vessel [62] flows through a partial condenser [72], an electrostatic separator [67] for coalescing of oil-mist and a phase separation vessel [63] from where the third condensed oil fraction [111] flows through a pump [82] and a cooler [85] joining the oil feed stream [7] serve as an input to hydrotreating process. The gas phase [112] flows to the third absorber vessel [64] where an oil fraction [113] is separated at the bottom and a gas stream [122] is removed at the top and conducted to the downstream gas and water separation and treatment unit. The condensed oil fraction [113] from the bottom of the vessel [64] flows through a pump [83] and a heat exchanger [74] to a distillation column [65] that is provided with a reboiler [75], condenser [77] and overhead separation vessel [66] where the non-condensable gas [116] is separated from the condensed light-end oil fraction [117] and flows to gas treatment [26], while the condensed oil fraction is pumped via pump [85] in part back as reflux [118] for vessel [65] and in part [119] joins the oil feed stream [7] serve as an input to hydrotreating process. From the bottom of the distillation column [65] the oil fraction product [120] flows through a pump [84] and heat-exchanger [74], and then is split into a recycle stream [123] going to the top of the absorber vessel [64] and an oil stream [121] passing through a cooler [76] and joining the other recovered oil fractions [7] on the way to hydrotreating. The recovered oil fractions generally are not mixed until they enter the hydrotreating process due to their different compositions, polarity, viscosity, density and solubility that in some cases may cause phase separation.

The control system is applied to the gas and liquid phases in the oil recovery condensers and vessels in order to provide narrow process control of oil viscosity and gas composition at each stage of the multi-step condensation process. The gas phase is measured quickly by FT-IR, and the liquid phase can be measured by gas chromatography or in the case of liquid samples at room temperature by total “internal reflection IR spectroscopy” where the oil passes directly over a ZnSe crystal or its equivalent. For liquid-phase tar-oil condensate fractions with high melting point and high viscosity at ambient temperature, a sampling technique that combines automatic volumetric solvent dilution prior to cooling and IR-spectroscopy analysis can be devised and employed.

ANCILLARY PROCESS SECTIONS: Several ancillary plant sections support the key process sections described above. These include water and gas recovery and cleanup, hydrogen production based on coal-gasification, cogeneration of electricity and steam, safety and emissions control systems. A substantial amount of water is removed from the coal during the process. For example, a 10,0004/d CCI plant supplying a 500-MW power plant and 7500-bbl/d synthetic crude oil based on “reference” LRC, will produce 3,300-t/d water or 137-tons/h (550-gpm). As a useful byproduct for boiler-feed water and cooling-tower water supply, the water is recovered and cleaned, removing all the contaminants, e.g., ammonia, mercury, organic compounds and sulfur compounds with conventional water treatment processes including ultra-filtration, gas stripping and adsorption.

The control system is applied to the ancillary process sections in order to support the optimization of the operation with regard to gas composition and water composition at various points in the process. This supports energy optimization.

1-31. (canceled)

32. A method for real-time monitoring and on-line control of a low-rank-coal pyrolysis process, said method comprising:
monitoring and measuring by a plurality of measuring instruments, the composition of an solid phase, a gas phase and a liquid phase in an intermediate stage of pyrolysis process, and determining the concentration of a plurality of compounds in each phase;
analyzing data on the measured concentration of the plurality of compounds, utilizing a modified chi-square data manipulation fitting technique to determine a correlation factor between an end-product composition quality and the concentrations of the plurality of compound in the intermediate solid phase, the gas phase and the liquid phase;
providing an online closed loop control of one or more operating variables in real time, wherein on determining deviation in one of the plurality of compound, a feedback is given to a control system to control one or more operating variables.

33. The method of claim 32, wherein low-rank coal comprises lignite or sub-bituminous (A, B and C) coals, or bituminous C coals and blends of lignite, sub-bituminous and bituminous coals that together have processing characteristics similar to sub-bituminous coal with respect to non-agglomeration and softening point range.

34. The method of claim 32, wherein the low-rank-coal pyrolysis is a mild-temperature pyrolysis process, where the feed coal is heated within a range of 450° C. to 700° C.

35. The method of claim 32, wherein the pyrolysis process is a multi-step coal conversion process that includes the feed-coal preparation, drying, distillation and pyrolysis of low-rank coal.

36. The method of claim 33, wherein the plurality of measuring system and the control system is applied at several locations along the path of mass flow during feed-coal preparation, drying, distillation and pyrolysis process.

37. The method of claim 32, wherein the end-products are a coal-char product, a pyrolysis gas, and a complex multi-component coal-tar-oil.

38. The method of claim 32, wherein the plurality of measuring instruments comprise a combination of spectrometric technology including scanning in the infrared, visible, ultraviolet and microwave spectral regions.

39. The method of claim 32, wherein the process is conducted by means of and in a manner that the operating control variables permit optimization of the processing conditions of temperature, gas flows and pressure so as to allow optimization of the quality and material balance between the solid, liquid and gas phase products.

40. The method of claim 32, wherein the plurality of measuring instruments provide near-instant feedback to the control system including controls for temperature, pressure, flows of gases, liquids and solids, product quality and throughput, so that the operating variables can be adjusted within minutes or fractions thereof to allow more accurate control and maintain narrow control-error limits around the designated set-point values.

41. The method of claim 32, wherein controlling the one or more operating variable compensates for coal friability, reduction of particle size and changes in coal quality and composition in real-time.

42. The method of claim 32, wherein the one or more operating variables comprise pressure, gas flow rate, temperature, residence time, heating gas composition and gas velocity.

43. The method of claim 32, wherein the plurality of compounds in the solid phase, gas phase and liquid phase comprises three to twelve control compounds.

44. The method of claim 37, wherein the coal-char product composition quality include maximum allowable residual amounts of mercury, sulfur, nitrogen, water, volatile compounds and ash, and minimum allowable amounts of water, pyrolysis oil compounds, and volatile compounds.

45. The method of claim 44, wherein the maximum wt-% residual amount of mercury is less than 250-parts-per-billion; the maximum wt-% residual amount of sulfur is less than 1.5; the maximum wt-% residual amount of nitrogen is less than 1.5; the water maximum wt % residual amount is less than 8.0; the water maximum wt % residual amount is less than 4.0; the maximum wt-% of ash is a factor of N times the amount in the feed-coal, where N is 2.5 or 2.2 or 2.0 or 1.8 or 1.6 or 1.4 or 1.2; the minimum wt % of volatile compounds is 5 or 8 or 10 or 12 or 15.

46. The method of claim 37, wherein the processed coal-tar-oil composition quality include maximum allowable amounts of compounds with molecular weight above 350 Dalton and atmospheric equivalent boiling point (AEBP) range above 900° C. and minimum allowable amounts designated pyrolysis oil compounds including phenols, cresols, aliphatic hydrocarbons, olefins, aromatic compounds, polynuclear aromatic compounds, sulfur compounds, nitrogen compounds, and oxygen compounds.

47. The method of claim 46, wherein the maximum wt-% amount of 350+ Dalton material is less than 15 and the maximum wt % with AEBP above 900° C. is less than 25.

48. The method of claim 37, wherein the coal-tar-oil is hydrotreated using means of catalytic hydrotreating process for converting it to a “synthetic crude oil” and where the on-line control method is applied to process control of this processing step of producing the synthetic crude oil.

49. The method of claim 48, wherein the hydrotreating process is continuous and the feedstock to the hydrotreating process is the total coal-tar oil recovered from the pyrolysis process.

50. The method of claim 48, wherein the hydrotreating process is continuous.

51. The method of claim 48, wherein the feedstock to the hydrotreating process is a fraction of the coal-tar oil recovered from the pyrolysis process; or a fraction of the coal-tar oil recovered from the pyrolysis containing most of the olefinic compounds; or a fraction of the coal-tar oil recovered from the pyrolysis containing most of the sulfur and/or nitrogen compounds; or a fraction of the coal-tar oil recovered from the pyrolysis containing most of the high-molecular and high boiling range compounds; or a mixture of various fractions of the coal-tar oil recovered from the pyrolysis containing various proportions of the recovered compounds.
